(19) United States
(12) Patent Application Publication
(10) Pub. No.: US 2007/0286053 A1
(43) Pub. Date: Dec. 13, 2007

(54) Optical pickup and optical drive

(75) Inventor: Katsuhiko Izumi, Kamakura (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi Media Electronics Co., Ltd., Iwate (JP)

(21) Appl. No.: 11/700,713

(22) Filed: Jan. 30, 2007

(30) Foreign Application Priority Data
Jun. 9, 2006 (JP) 2006-160427

(51) Int. Cl. G11B 7/00

(52) U.S. Cl. 369/112.13

(57) ABSTRACT

When a dual-layer disc was read, light returning from an irrelevant layer interfered with signal light, causing a focusing error signal and tracking error signal to vary. As a result, full-expected performance could not be obtained from an optical pickup.

Disclosed is an optical pickup that includes a laser diode, which emits an optical beam; a diffraction device, which is placed at a position through which the optical beam passes, and separates the optical beam into at least three optical beams (zero-order light, plus first-order light, and minus first-order light); an objective lens, which condenses the optical beams passing through the diffraction device on an optical disc; and a detector, which receives light reflected from the optical disc. The diffraction device allows only a specific polarization direction component of an optical beam to pass without being diffracted, and diffracts a polarization direction component that is orthogonal to the former component.

### BACKGROUND OF THE INVENTION

The present invention relates to an optical pickup and optical drive.

A background art for the above technical field is disclosed, for instance, by Japanese Patent Laid-Open No. 269587/1998. An object of the invention disclosed by Japanese Patent Laid-Open No. 269587/1998 is to make it easy to prevent the generation of unnecessary stray light and achieve signal detection simultaneously by the push-pull method and three-beams method. To achieve such an object, the disclosed invention includes a first diffraction device, which divides an incoming optical beam into three beams (zero-order beam or main beam and ±first-order beams or ±sub-beams); a second diffraction device, which has a plurality of diffraction regions; and a beam splitter, which separates an optical beam reflected from a recording medium in two directions. Further, a first detector, which includes a plurality of detectors that are linearly arranged in the direction of recording medium tracks, is positioned in one of the optical paths provided by the beam splitter so as to receive only the main beam, and a second detector, which includes a plurality of detectors, is positioned in the other optical path so that the detectors receive one of a zero-order light component and ±first-order light components.

### SUMMARY OF THE INVENTION

In an optical disc system, a dual-layer disc, which has a dual-layered signal recording surface, exists in order to offer an increased recording capacity. As regards DVDs, for instance, dual-layer DVD-R and DVD-RW discs exist. These dual-layer optical discs have approximately two times the capacity of a single-layered optical disc. Dual-layer discs also exist in a high-density recording optical disc system called a Blu-ray Disc (BD) system.

An optical pickup that is mounted in an optical drive uses light reflected from an optical disc as a focusing/tracking direction servo control signal for an objective lens. Therefore, if unnecessary stray light is added to the reflected light, which is to be used as the signal, a problem occurs in signal detection.

When the optical pickup, which uses a detector to receive the light reflected from an optical disc after an optical beam emitted from a laser diode is separated into at least three optical beams (zero-order beam and ±first-order beams) and shed on the optical disc, performs a read/write operation in relation to a dual-layer disc, unnecessary light reflected from an irrelevant layer becomes a stray light component, thereby causing disturbance to a tracking signal.

Although Patent Document 1 does not consider the stray light from an irrelevant layer, an object of the invention disclosed by Patent Document 1 is to make it easy to prevent the generation of unnecessary stray light and achieve signal detection simultaneously by the push-pull method and three-beams method. To achieve such an object, the disclosed invention includes a first diffraction device, which divides an incoming optical beam into three beams (zero-order beam or main beam and ±first-order beams or ±sub-beams); a second diffraction device, which has a plurality of diffraction regions; and a beam splitter, which separates an optical beam reflected from a recording medium in two directions. Further, a first detector, which includes a plurality of detectors that are linearly arranged in the direction of recording medium tracks, is positioned in one of the optical paths provided by the beam splitter so as to receive only the main beam, and a second detector, which includes a plurality of detectors, is positioned in the other optical path so that the detectors receive one of a zero-order light component and ±first-order light components.

However, the invention disclosed by Patent Document 1 divides a diffraction region to eliminate the stray light component so that the separated diffraction regions receive only the plus (+) first-order light component or minus (−) first-order light component. Therefore, the light quantity of the diffracted optical beam is reduced to less than half of its original value. As a result, the resulting detected signal becomes smaller. Further, since the ±first-order optical beams are generated from different divided regions, the diffracted light quantity ratio between the divided regions is likely to vary so that the ±first-order light spots on the optical disc cannot readily be positioned symmetrically with respect to a point of zero-order light. This makes it difficult to obtain a good servo signal.

An object of the present invention is to provide a highly reliable optical pickup and optical drive.

The above object can be achieved by ensuring that the polarizations of the zero-order light and ±first-order light are substantially orthogonal to each other in a light detection plane.

The present invention makes it possible to provide a highly reliable optical pickup and optical drive.

### BRIEF DESCRIPTION OF THE DRAWINGS

These and other features, objects, and advantages of the present invention will become more apparent from the following description when taken in conjunction with the accompanying drawings wherein:

FIG. 1 shows the configuration of an optical pickup according to a first embodiment;

FIG. 2 shows a laser chip that is mounted in a laser diode and illustrates polarization;

FIG. 3 shows the positional relationship between a polarized grating and the polarization direction of an optical beam emitted from the laser diode;

FIG. 4 shows how an optical beam is diffracted by the polarized grating;

FIGS. 5A and 5B show how an optical beam is polarized by the optical pickup;

FIG. 6 shows the relationship between the angle of polarized light incident upon the polarized grating and the quantities of zero-order light and ±first-order light;

FIGS. 7A and 7B show the state of an optical beam that prevails when a dual-layer disc is read;

FIGS. 8A and 8B show the states of spots on a detector that prevail when a dual-layer disc is read;

FIG. 9 shows an optics configuration of the optical pickup according to a second embodiment;

FIG. 10 shows the optics configuration of the optical pickup according to a third embodiment;

FIGS. 11A and 11B show a grating and polarization according to a fourth embodiment; and

FIG. 12 is a schematic block diagram illustrating an optical drive in which the optical pickup according to the first, second, third, or fourth embodiment.

### DETAILED DESCRIPTION OF THE PREFERRED EMBODIMENTS

Embodiments (first to fifth embodiments) of the present invention will now be described.

### First Embodiment

The configuration of an optical pickup according to a first embodiment of the present invention will now be described with reference to the accompanying drawings.

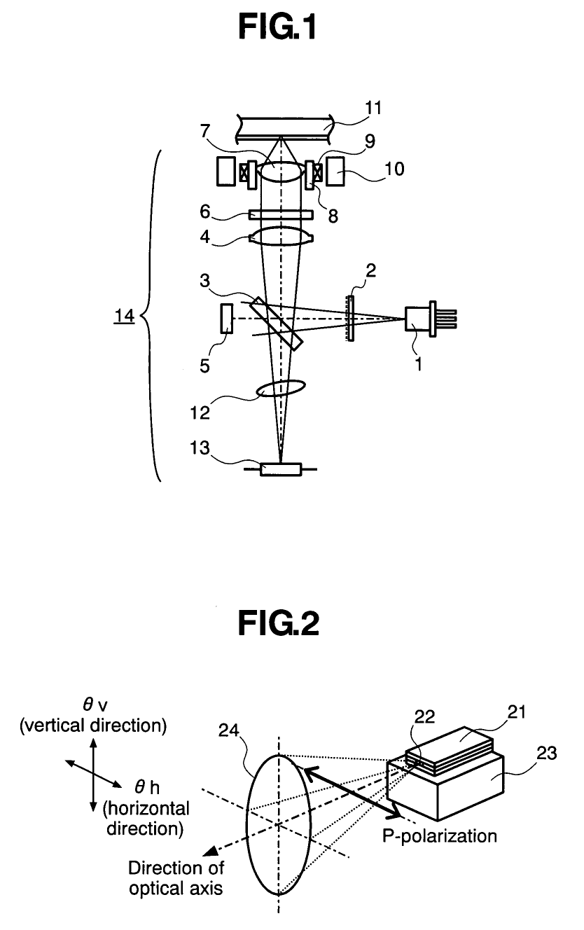

FIG. 1 shows the configuration of the optical pickup according to the first embodiment. Referring to FIG. 1, a laser diode is capable of oscillating at a wavelength of 405 nm. At a normal temperature, the laser diode oscillates at a wavelength of 405 nm. It should be noted that BD read/write operations can be performed at a wavelength of 405 nm. FIG. 1 shows a state in which an optical beam having a wavelength of 405 nm is emitted. The laser diode 1 is rotated around an optical axis of the optical beam so that the optical beam emitted from the laser diode 1 is a polarized optical beam parallel to a plane that is rotated through an angle of α around the optical axis of the optical beam with respect to a direction parallel to the paper surface as described later.

The optical beam reaches a polarized grating 2, which is positioned immediately before the laser diode. The polarized grating 2 is used to separate the incoming optical beam into three optical beams (zero-order optical beam and ±first-order optical beams) in accordance with the polarization of the incoming optical beam and generate three light spots on an optical disc. Details will be given later. The optical beam is separated into three optical beams (zero-order optical beam and ±first-order optical beams) by a grating surface of the polarized grating 2 and delivered to a half mirror 3.

The half mirror 3 is positioned at an angle of 45° from the optical axis of the optical beam emitted from the laser diode 1. The half mirror 3 is an optical device whose surface film reflects approximately 80% of a p-polarization component of the optical beam having a wavelength of 405 nm and approximately 70% of a p-polarization component. Therefore, a certain amount of the optical beam that reaches the half mirror 3 bounces off at an angle of 90° from the direction of incidence. The quantity of the optical beam that bounces off as mentioned above is determined in accordance with its polarization. Part of the optical beam is transmitted through the half mirror 3 and delivered to a front monitor 5, which monitors the light quantity of the optical beam.

The optical beam reflected from the reflection film of the half mirror 3 is converted to a collimated optical beam by a collimating lens 4. The optical beam emitted from the collimating lens 4 is transmitted through a quarter wavelength plate 6. The optical beam transmitted through the collimating lens 4 is converted to circularly polarized light by the quarter wavelength plate 6 and shed on an objective lens 7. When the optical beam having a wavelength of 405 nm is an incoming collimated beam, the objective lens 7 can achieve focusing with respect to an information recording surface of a first optical disc 11, which is a BD or other disc having a substrate thickness of 0.1 mm.

The objective lens 7 is retained by an actuator 8, which is integral with a drive coil 9. A magnet 10 is positioned to face the drive coil 9. Therefore, when the drive coil 9 is energized to generate a driving force that is based on a reaction force from the magnet 10, the objective lens 7 can be moved substantially in the radial direction of the optical disc 11 and in the direction perpendicular to a disc surface. The optical beam transmitted through the objective lens 7 is such that the light quantity of the optical beam transmitted through the objective lens 7 or the light quantity of a light spot formed on the optical disc 11 can be estimated from the light quantity detected by the front monitor 5.

The optical beam reflected from the optical disc 11 moves in a reverse direction along the same optical path that is used for the incoming light, and reaches the quarter wavelength plate 6 via the objective lens 7. In this instance, the polarization of the optical beam is mostly circular polarization as is the case with the incoming light. Therefore, the optical beam is converted to polarized light that is orthogonal to the incoming light when it is transmitted through the quarter wavelength plate 6. Subsequently, the optical beam is shed on the collimating lens 4, converted from collimated light to converged light by the collimating lens 4, and delivered to the half mirror 3. When the optical beam reaches the half mirror 3, the film surface of the half mirror 3 works so that 20 to 30% of the optical beam is transmitted through the half mirror 3.

The optical beam transmitted through the half mirror 3 has already been converged when it is transmitted through the collimating lens 4. The optical beam is given an astigmatic aberration when it is transmitted through the half mirror 3, which is inclined at an angle of 45° to the direction of an optical beam travel. Subsequently, the optical beam is transmitted through a detection lens 12 and then condensed on a predetermined light detection surface of a detector 13. The detection lens 12 is used to cancel a coma aberration that occurs in the half mirror 3, and to increase the composite focal length of a detection system. Upon receipt of the optical beam, the detector 13 can output, for instance, a servo signal and read signal that are fed from the optical disc 11.

The optical pickup 14 comprises a combination of optical parts and electrical parts described above.

A laser chip mounted in the laser diode and polarization will now be described with reference to FIG. 2. Referring to FIG. 2, the laser chip 21 emits an optical beam having a wavelength of 405 nm. It is mounted on a substrate 23 and incorporated in the laser diode 1 shown in FIG. 1. An active layer 22 is formed in the laser chip 21. An optical beam is emitted from an end face of the active layer. The optical beam having a wavelength of 405 nm, which is emitted in the direction substantially parallel to the longitudinal direction of the laser chip 21 from the end face of the active layer 22 in the laser chip 21, has a narrow divergence angle in the direction θh parallel to the active layer 22 (horizontal direction) with respect to the optical axis of the optical beam and a wide divergence angle in the direction θv parallel to the active layer 22 (vertical direction). For example, the divergence angles are approximately 9° and 18°, respectively. The optical beam divergence 24 has an elliptic intensity distribution that is long in the θv direction. The oscillation plane of the optical beam emitted from the laser chip 21 substantially agrees with the plane parallel to the active layer 22, that is, the θh direction. The optical beam oscillates in the direction indicated by an arrow in the figure and is in the p-polarization state.

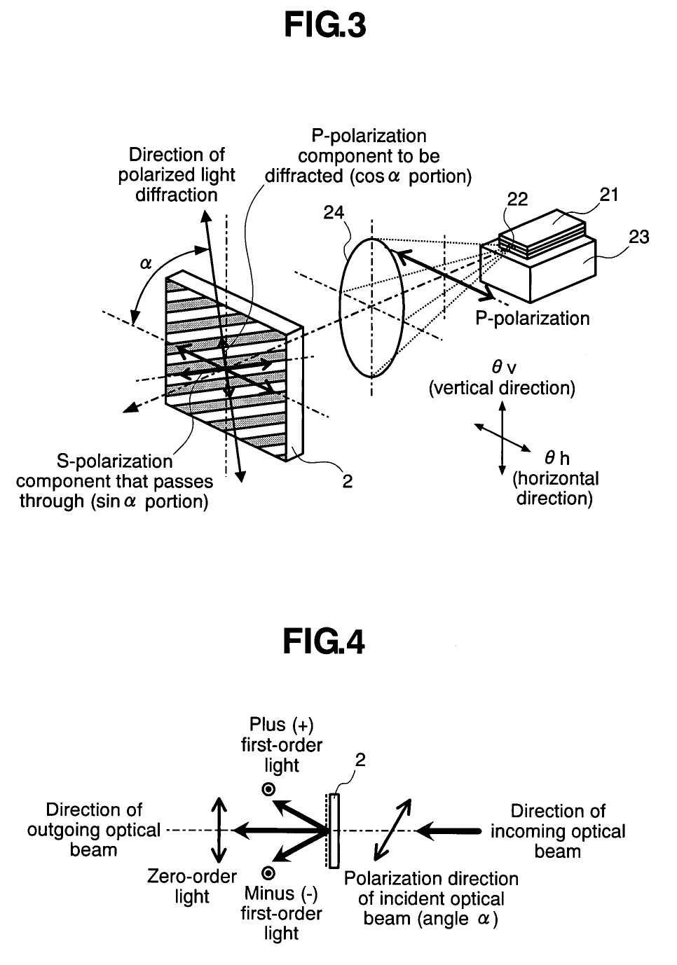

The positional relationship between the polarized grating and the polarization direction of an optical beam emitted from the laser diode will now be described with reference to FIG. 3. The laser diode is as described with reference to FIG. 2. Referring to FIG. 3, the optical beam emitted from the laser chip 21 is polarized in the plane parallel to the active layer 22, that is, p-polarized in the θh direction. Meanwhile, the polarized grating 2, which is positioned before the laser diode 1, diffracts p-polarized light and is positioned so that the direction of diffraction, that is, the direction orthogonal to a groove structure of the grating, is inclined at an angle of α to the θh direction shown in the figure. Thus, some portion of the optical beam incident on the polarized grating is diffracted by the polarized grating, and the other portion passes through the polarized grating without being diffracted. More specifically, the portion corresponding to cost (that is, p-polarized light) is diffracted as ±first-order light by the polarized grating, and the portion corresponding to sin α (that is, s-polarized light) passes through the polarized grating as zero-order light without being diffracted.

FIG. 4 shows how the optical beam is diffracted by the polarized grating. The optical beam diffraction shown in this figure is as viewed from the direction of the cross section orthogonal to the grating groove of the polarized grating. Therefore, the optical beam that falls on the polarized grating 2 from the right-hand side of the figure is linearly polarized light whose oscillation plane is inclined at an angle of α to the paper surface. As described with reference to FIG. 3, the optical beam that is a p-polarization component for the grating is diffracted by the polarized grating 2 as the ±first-order light at a predetermined angle. Therefore, the quantity of light corresponding to cos α is separated into plus (+) first-order light and minus (−) first-order light and diffracted. In this instance, the diffracted ±first-order light is polarized as p-polarized light whose oscillation plane is perpendicular to the paper surface indicated by circles in the figure. Meanwhile, the quantity of light corresponding to sin α, which is incident on the polarized grating 2, passes through the polarized grating 2 as zero-order light. In this instance, the zero-order light is polarized as s-polarized light whose oscillation plane is parallel to the paper surface indicated by circles in the figure. Consequently, in the present embodiment, the zero-order light transmitted through the polarized grating 2 is s-polarized light, whereas the ±first-order light becomes p-polarized light. In other words, the zero-order light and ±first-order light are polarized in directions orthogonal to each other.

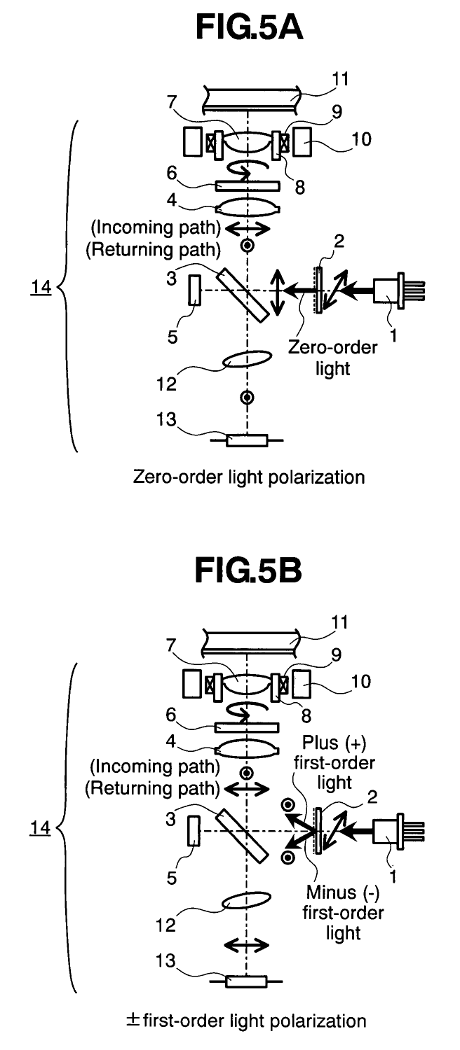

The optical beam polarization in the optical pickup will now be described with reference to FIGS. 5A and 5B. FIG. 5A shows how the zero-order light is polarized. FIG. 5B shows how the ±first-order light is polarized. The component parts shown in FIGS. 5A and 5B will not be described here because they have already been described with reference to FIG. 1. Referring to FIG. 5A, the optical beam emitted from the laser diode 1 falls on the polarized grating 2. In this instance, the optical beam is linearly polarized light whose oscillation plane is inclined at an angle of α to the paper surface as described with reference to FIG. 4. Thus, the light quantity of the optical beam incident on the polarized grating 2 that corresponds to sin α passes through the polarized grating 2 as zero-order light without being diffracted. In this instance, the zero-order light is polarized as s-polarized light whose oscillation plane is parallel to the paper surface indicated by an arrow in the figure.

The zero-order light emitted from the polarized grating 2 bounces off the half mirror 3 and reaches the collimating lens 4. Approximately 80% of the zero-order light bounces off the half mirror 3. The zero-order light reflected in this manner is polarized in the direction parallel to the paper surface as designated “Incoming path” in the figure. Subsequently, the zero-order light is transmitted through the quarter wavelength plate 6 via the collimating lens 4. The quarter wavelength plate 6 converts the zero-order light to circularly polarized light. The zero-order light then falls on the objective lens 7, and bounces off the recording surface of the disc 11. The reflected zero-order light, which remains circularly polarized, reaches the quarter wavelength plate 6 via the objective lens 7. When the zero-order light is transmitted through the quarter wavelength plate 6, it is converted to polarized light that is orthogonal to the incoming light. In other words, the zero-order light becomes p-polarized light, which is polarized in the direction perpendicular to the paper surface indicated by a circle in the figure. Subsequently, the zero-order light falls on the collimating lens 4. The zero-order light is then converted from collimated light to converged light by the collimating lens 4, and delivered to the half mirror 3. When the optical beam is delivered to the half mirror 3, 30% of its light quantity is transmitted through the half mirror 3 due to the characteristics of the film on the half mirror 3. The zero-order light is then transmitted through the detection lens 12 and condensed on the predetermined light detection surface of the detector 13. However, the zero-order light is polarized as p-polarized light that is perpendicular to the paper surface as indicated by a circle in the figure.

The polarization of the ±first-order light will now be described. Referring to FIG. 5B, the optical beam emitted from the laser diode 1 falls on the polarized grating 2. In this instance, the optical beam is linearly polarized light whose oscillation plane is inclined at an angle of α to the paper surface as described with reference to FIG. 4. Thus, the optical beam serving as a p-polarization component is diffracted by the polarized grating 2 as the ±first-order light at a predetermined angle. In other words, the quantity of light corresponding to cos α of the optical beam is separated into plus (+) first-order light and minus (−) first-order light and diffracted. In this instance, the diffracted ±first-order light is polarized as p-polarized light whose oscillation plane is perpendicular to the paper surface indicated by a circle in the figure.

Since the ±first-order light emitted from the polarized grating 2 is p-polarized light, approximately 70% of the ±first-order light bounces off the half mirror 3 and reaches the collimating lens 4. The reflected ±first-order light is polarized in the direction perpendicular to the paper surface indicated by a circle as designated “Incoming path” in the figure. Subsequently, the ±first-order light is transmitted through the quarter wavelength plate 6 via the collimating lens 4. The quarter wavelength plate 6 converts the ±first-order light to circularly polarized light. The ±first-order light then falls on the objective lens 7, and bounces off the recording surface of the disc 11. The reflected ±first-order light, which remains circularly polarized, reaches the quarter wavelength plate 6 via the objective lens 7. When the ±first-order light is transmitted through the quarter wavelength plate 6, it is converted to polarized light that is orthogonal to the incoming light. In other words, the ±first-order light becomes s-polarized light, which is polarized in the direction parallel to the paper surface indicated by an arrow in the figure. Subsequently, the ±first-order light falls on the collimating lens 4. The ±first-order light is then converted from collimated light to converged light by the collimating lens 4, and delivered to the half mirror 3. When the optical beam is delivered to the half mirror 3, 20% of its light quantity is transmitted through the half mirror 3 due to the characteristics of the film on the half mirror 3. The ±first-order light is then transmitted through the detection lens 12 and condensed on the predetermined light detection surface of the detector 13. However, the ±first-order light is polarized as s-polarized light that is parallel to the paper surface indicated by an arrow in the figure.

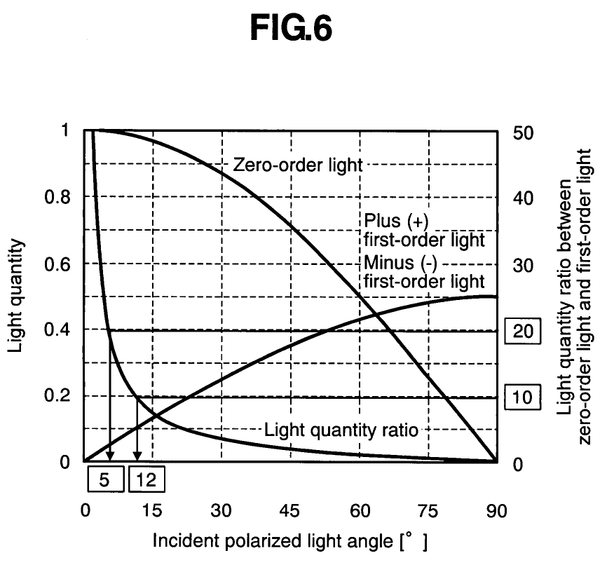

The relationship between the angle of polarized light incident upon the polarized grating and the quantities of zero-order light and ±first-order light will now be described. FIG. 6 shows the relationship between the angle of polarized light incident upon the polarized grating and the quantities of zero-order light and ±first-order light. For the sake of simplicity, it is assumed that the polarized grating according to the first embodiment diffracts the p-polarization component into a plus (+) first-order optical beam and minus (−) first-order optical beam whose light quantities are both reduced to half the original quantity. Therefore, if the incident polarization angle is 0°, the whole quantity of light passes through without being diffracted. As a result, the quantity of zero-order light is 1 and the quantities of plus (+) first-order light and minus (−) first-order light are 0. When the incidence angle of incident polarized light varies, the p-polarization component to be diffracted increases in quantity. Therefore, the zero-order light decreases in quantity, whereas the plus (+) first-order light and minus (−) first-order light, which exhibit the same behavior as indicated in the figure, increase in quantity. As regards the light quantity ratio between the zero-order light and ±first-order light during the use of a differential push-pull method, which uses three beams, the quantity of ±first-order light cannot be significantly increased from the viewpoint of preventing the ±first-order light from erasing a recording mark on the optical disc. Therefore, the upper-limit light quantity ratio between the zero-order light and ±first-order light is approximately 10:1. Meanwhile, a certain quantity of ±first-order light is required for making a detected signal component less susceptible to noise. Therefore, the lower-limit light quantity ratio between the zero-order light and ±first-order light is approximately 20:1. In other words, when the light quantity ratio between the zero-order light and ±first-order light is between 10:1 and 20:1, the optical pickup can deliver satisfactory performance. To ensure that the light quantity ratio between the zero-order light and ±first-order light is between 10:1 and 20:1, the first embodiment sets an angle between 5° and 12° as the angle of polarized light incident on the polarized grating. This makes it possible to set an optimum light quantity ratio between the zero-order light and ±first-order light, that is, an optimum spectral ratio.

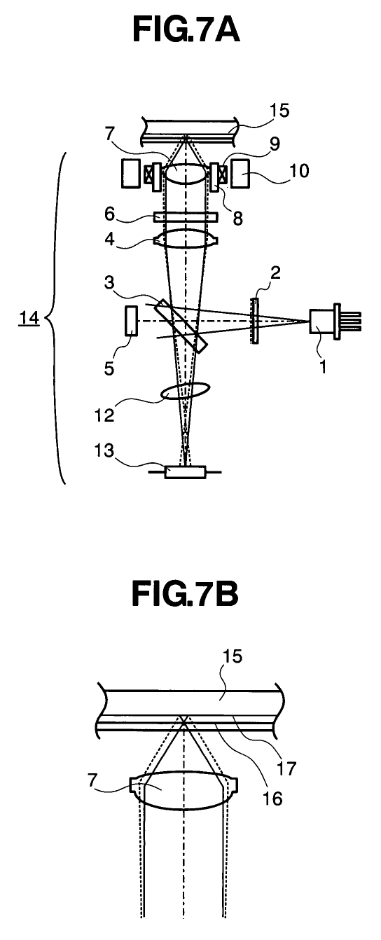

The state of an optical beam that prevails when a dual-layer disc is read will now be described with reference to FIGS. 7A and 7B. FIG. 7A shows the state of an optical beam that prevails when a dual-layer disc is read. FIG. 7B shows the state of an optical beam that prevails within the dual-layer disc. The configuration of optical parts will not be described here because it is the same as described with reference to FIG. 1.

As described earlier, the objective lens 7 condenses the optical beam emitted from the laser diode 1 on the recording surface 16 of the optical disc 15 to be read. The optical beam reflected from the recording surface 16 travels along the same optical path as for the incoming beam and reaches the detector as indicated by a solid line in the FIG. 7A. The dual-layer disc is an optical disc that has two recording surfaces 16 and 17. Recording surface 16, which is positioned forward as viewed from the objective lens 7, has such characteristics that it reflects a predetermined quantity of optical beam, transmits a predetermined quantity of optical beam, and delivers the transmitted optical beam to recording surface 17. Therefore, when the optical beam is condensed on recording surface 16, a predetermined quantity of optical beam is always transmitted through recording surface 16. The optical beam that is condensed on recording surface 16 and then transmitted through recording surface 16 totally bounces off recording surface 17 as indicated by a broken line in the figure, and reaches the collimating lens 4 via the objective lens 7. The optical beam reflected from recording surface 17, which is indicated by the broken line, is converged in a manner different from the manner of convergence of the optical beam reflected from recording surface 16, which is indicated by a solid line. Thus, the optical beam is temporarily condensed before it reaches the detector 13, and the effective diameter of the optical beam on the detector 13 is slightly increased.

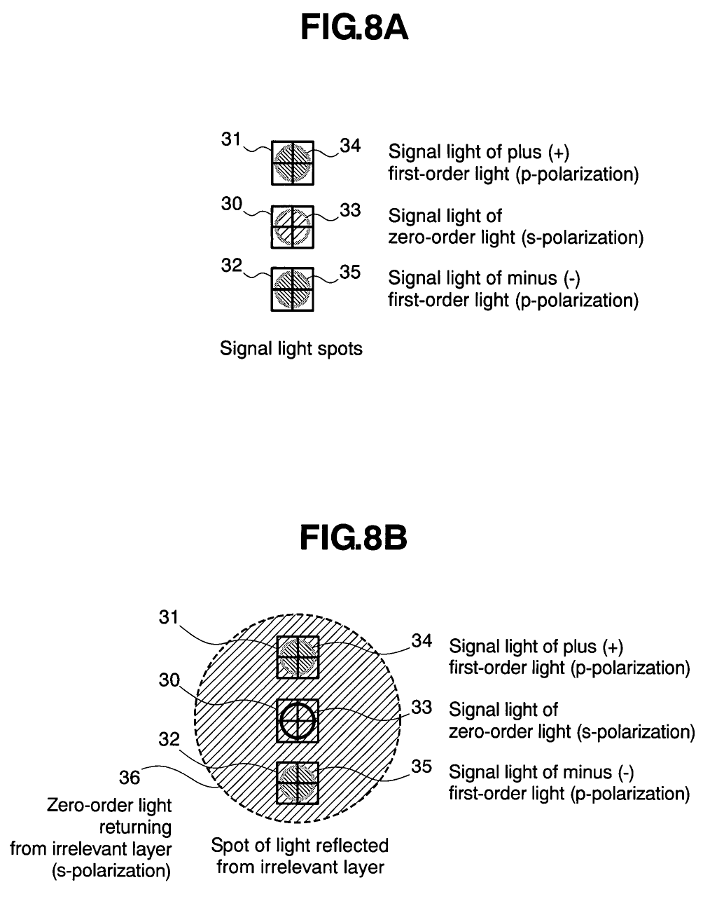

FIGS. 8A and 8B show spots that are formed on the detector when the dual-layer disc is read. FIG. 8A shows spots of signal light that is delivered from a desired recording surface. FIG. 8B additionally shows a spot of light that is reflected from another recording surface. The detector incorporates three light reception surfaces (light reception surfaces 30, 31, and 32) that are divided into four sections. The detector is positioned so that three beams of signal light are shed on the light reception surfaces from the desired recording surface. Zero-order signal light 33 falls on light reception surface 30. Plus (+) first-order signal light 34 falls on light reception surface 31. Minus (−) first-order signal light 35 falls on light reception surface 32. Therefore, when output signals generated from light reception surfaces 30, 31, and 32 are computed, it is possible to output a focusing error signal by the astigmatic detection method or differential astigmatic detection method and a tracking error signal by the differential push-pull method. The astigmatic detection method, differential astigmatic detection method, and differential push-pull method will not be described in detail because they are publicly known. As described earlier, the first embodiment is configured so that linearly polarized light is incident at a predetermined angle to the polarized grating. Therefore, the light falls on the optical disc in such a manner that the polarization direction of zero-order light is orthogonal to that of ±first-order light, and then returns to the detector. Consequently, the zero-order signal light 33 on the detector is s-polarized light, which is shaded in the figures with lines slanting upward to the right; the plus (+) first-order signal light 34 is p-polarized light, which is shaded with lines slanting upward to the left; and the minus (−) first-order signal light 35 is p-polarized light as well.

When the dual-layer disc is to be read, the zero-order light returning from the irrelevant layer, that is, returning light 36, falls on the detector surface as described with reference to FIGS. 7A and 7B. The returning light 36 is substantially concentric with the zero-order signal light, and its diameter is so large that it contains not only light reception surface 30 but also light reception surfaces 31 and 32, as indicated in FIG. 8B. The returning light 36, which falls on the same light reception surface 31 as for the plus (+) first-order signal light 34, has substantially the same light quantity as the plus (+) first-order signal light 34 or one-severalth the light quantity of the plus (+) first-order signal light 34, but has virtually the same optical path length as the plus (+) first-order signal light 34. Therefore, if the returning light 36 and plus (+) first-order signal light are in the same polarization state, the returning light 36 interferes with the plus (+) first-order signal light due to interplanar spacing variation between recording surfaces 16 and 17. In such an instance, the focusing error signal and tracking error signal obtained from light reception surface 31 may vary due to interference. In the first embodiment of the present invention, the returning light 36 is s-polarized, whereas the plus (+) first-order signal light 33 is p-polarized. Therefore, the returning light 36 slightly increases its light quantity at light reception surface 31, but does not become a factor for interference-induced variation. Thus, the focusing error signal and tracking error signal, which can be output from light reception surface 31, do not vary due to interference.

### Second Embodiment

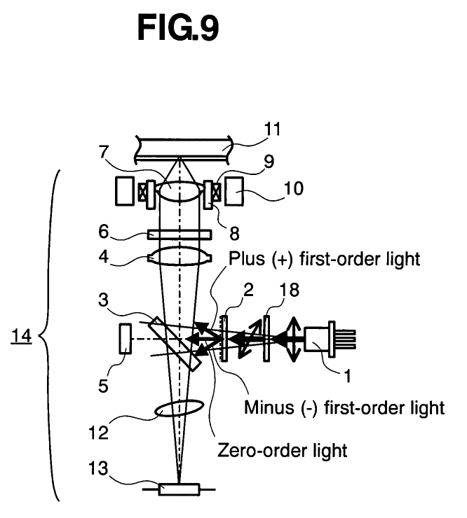

A second embodiment of the present invention will now be described with reference to FIG. 9. Basic optical parts shown in FIG. 9 are arranged in the same manner as the counterparts shown in FIG. 1. The same parts are assigned the same reference numerals. The second embodiment differs from the first embodiment, which is shown in FIG. 1, in that a half wavelength plate 18 is positioned between the laser diode 1 and polarized grating 2. The half wavelength plate 18 is an optical device for rotating the polarization direction by an angle that is twice the angular difference between an internal azimuth angle setting and incident polarization angle setting. Therefore, the half wavelength plate 18 makes it possible to perform setup for changing as desired the polarization direction of linearly polarized light emitted from the laser diode 1. In other words, the incident polarization angle relative to the polarized grating 2 can be set without changing the angle of the laser diode 1 around the optical axis. This makes it easy to adjust the light quantity ratio between the ±first-order light, which is diffracted by the polarized grating 2, and the zero-order light, which is not diffracted. As a result, even when the polarization angle of the optical beam emitted from the laser diode 1 varies, it is easy to set the incident polarization angle relative to the polarized grating 2.

### Third Embodiment

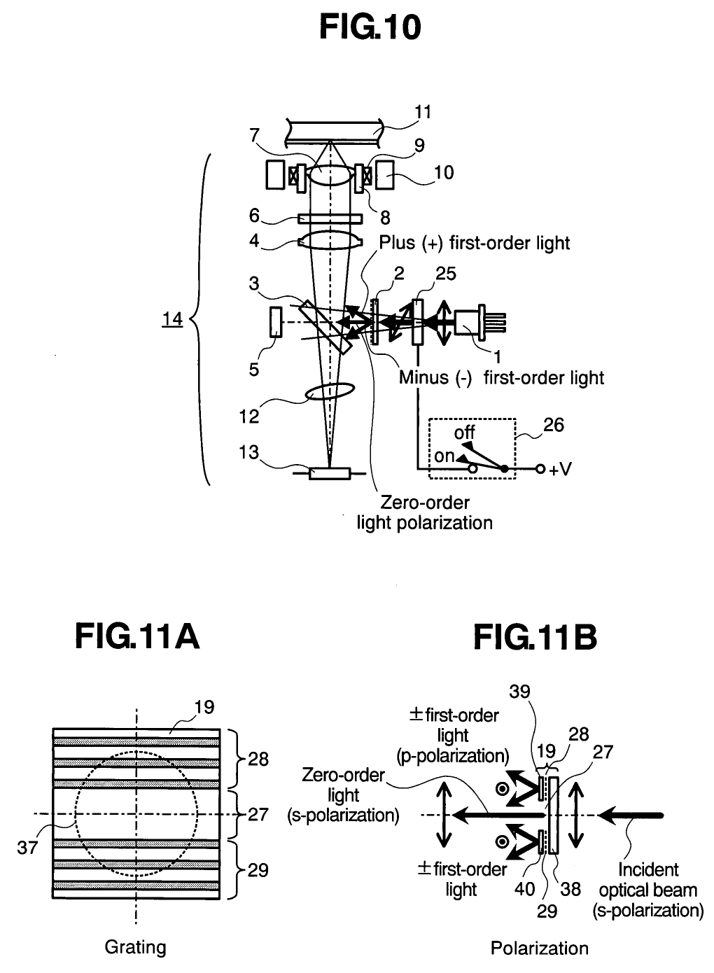

A third embodiment of the present invention will now be described with reference to FIG. 10. Basic optical parts shown in FIG. 10 are arranged in the same manner as the counterparts shown in FIG. 9. The same parts are assigned the same reference numerals. The third embodiment differs from the second embodiment, which is shown in FIG. 9, in that a liquid-crystal device 25 is positioned between the laser diode 1 and polarized grating 2 instead of the half wavelength plate 18. The liquid-crystal device 25 can change the angle of the polarization direction of incident polarized light upon power on/off. When a switch 26 is operated to turn on/off the power, the liquid-crystal device 25 turns on/off the half wavelength plate function incorporated in the liquid-crystal device 25. Therefore, the polarized light incident on the polarized grating 2 can be placed in at least two different polarization states. Even when the polarization angle of the optical beam emitted from the laser diode 1 varies, it is possible to set the incident polarization angle relative to the polarized grating 2 with ease and adjust the quantity of the ±first-order light that diffracts the polarized grating 2.

### Fourth Embodiment

A fourth embodiment of the present invention will now be described with reference to FIGS. 11A and 11B. FIG. 11A shows the pattern of a grating according to the fourth embodiment. FIG. 11B shows how the optical beam is polarized when it is transmitted through the grating. As indicated in FIG. 11A, a part of the surface of a substrate 38 for the grating 19 is a central region 27, which has no grating groove. Normal grating regions 28 and 29, which are not particularly dependent on polarization, are formed at both ends of the central region 27. The grating regions 28 and 29 are positioned apart from each other so that the effective diameter 37 of the optical beam passing through the grating 19 partly overlap with them. Further, half wavelength plates 39 and 40 (not shown) are attached to the grating regions 28 and 29.

Referring to FIG. 11B, the optical beam emitted from the right-hand side of the grating 19 is s-polarized light that is parallel to the paper surface indicated by an arrow in the figure. When the optical beam falls on the grating 19, the portion incident on the central region 27 merely passes through. Thus, the polarization direction of the optical beam that passes through the central region 27 does not particularly change so that the optical beam remains to be s-polarized light parallel to the paper surface. Meanwhile, the optical beam that is transmitted through the grating regions 28 and 29 is separated into ±first-order light beams, respectively, due to the groove structure of the grating. Since the half wavelength plates 39 and 40 are integrally attached to the grating regions 28 and 29, respectively, the ±first-order light emitted from the grating 19 can be p-polarized. Consequently, the polarization directions of the zero-order light and ±first-order light are rendered orthogonal to each other by using a configuration that differs from that of an expensive polarized grating. In other words, the use of the grating 19 according to the fourth embodiment makes it possible to avert the influence of light returning from an irrelevant layer of the dual-layer disc as is the case with the first embodiment, and minimize interference-induced signal variations in the focusing error signal and tracking error signal.

### Fifth Embodiment

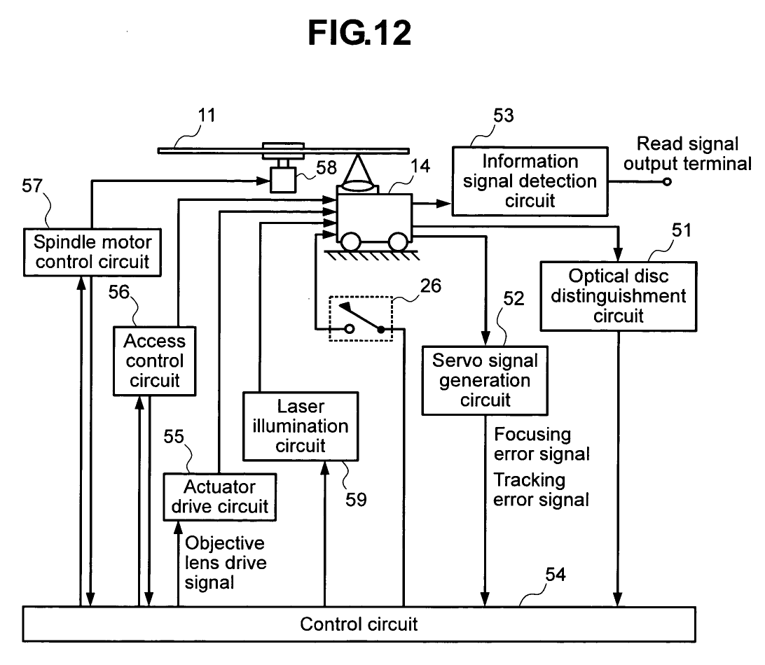

An optical drive in which the optical pickup according to the first to fourth embodiments is mounted will now be described. FIG. 12 is a schematic block diagram illustrating the optical drive according to a fifth embodiment, in which the optical pickup is mounted. A part of a signal detected by the optical pickup 14 is forwarded to an optical disc distinguishment circuit 51. The optical disc distinguishment operation performed in the optical disc distinguishment circuit 51 is based on the fact that, for example, the focusing error signal amplitude level detected by the optical pickup 14 is higher when the optical disc substrate thickness corresponds to the oscillation wavelength of an illuminated laser diode than when the optical disc substrate thickness corresponds to a different oscillation wavelength. The obtained distinguishment result is conveyed to a control circuit 54. Another part of the signal detected by the optical pickup 14 is forwarded to a servo signal generation circuit 52 or an information signal detection circuit 53. The servo signal generation circuit 52 generates a focusing error signal or tracking error signal appropriate for the optical disc 11 or dual-layer disc 15 from various signals detected by the optical pickup 14, and delivers the generated signal to the control circuit 54. The information signal detection circuit 53, on the other hand, detects an information signal recorded on the optical disc 11 or dual-layer disc 15 from a signal detected by the optical pickup 14, and outputs the detected information signal to a read signal output terminal. The control circuit 54 sets the optical disc 11 or dual-layer disc 15 in accordance with the signal received from the optical disc distinguishment circuit 51, and sends an objective lens drive signal to an actuator drive circuit 55 in accordance with a focusing error signal or tracking error signal that is generated by the servo signal generation circuit 52 in compliance with the signal generated by the optical disc distinguishment circuit 51. In accordance with the objective lens drive signal, the actuator drive circuit 55 drives the actuator 8 in the optical pickup 14 to control the position of the objective lens 7. Further, the control circuit 54 causes an access control circuit 56 to provide access direction positional control over the optical pickup 14, and operates a spindle motor control circuit 57 to control the rotation of a spindle motor 58 for the purpose of rotating the optical disc 11 or dual-layer disc 15. Furthermore, the control circuit 54 drives a laser illumination circuit 59 to properly illuminate the laser diode 1, which is mounted in the optical pickup 14, in accordance with the optical disc 11 or dual-layer disc 17, thereby performing an optical drive's read/write operation.

Here, it is possible to configure an optical disc reader that includes an information signal read section, which reads an information signal from a signal output from the optical pickup, and an output section, which outputs a signal output from the information signal read section. Further, it is possible to configure an optical disc writer that includes an information input section, which inputs an information signal, and a write signal generation section, which generates the signal to be written onto an optical disc from the information input from the information input section and outputs the generated signal to the optical pickup.

As described above, when the dual-layer disc is read in accordance with the embodiments described above, three beams generated by the grating can cause the optical pickup, which outputs the focusing error signal and tracking error signal, to polarize the ±first-order signal light in a direction orthogonal to the direction in which the zero-order light returning from the irrelevant layer is polarized, thereby avoiding interference caused by the returning light and preventing the focusing error signal and tracking error signal from varying. This makes it possible to provide a highly reliable optical pickup and optical drive.

The present invention is not limited to the use of the polarization directions according to the embodiments described above. The present invention can also be applied to a situation where the zero-order light is p-polarized with the ±first-order light s-polarized.

In the first to fourth embodiments, the optical pickup separates the optical beam into zero-order light and ±first-order light, and the polarized grating, which polarizes the zero-order light in a direction substantially orthogonal to the direction in which the ±first-order light is polarized, is positioned in the incoming path between the laser diode and half mirror. However, the present invention may employ a configuration in which the polarization direction of the zero-order light is substantially orthogonal to that of the ±first-order light in the detector plane. For example, a wavelength plate or polarization device may be used to change the polarization of either the zero-order light or ±first-order light after the grating separates the optical beam into the zero-order light and ±first-order light. The present invention does not restrict the location of a device for providing orthogonal polarizations or the means for providing orthogonal polarizations. The device for providing orthogonal polarizations may alternatively be positioned in the incoming and returning paths or in the returning path.

While we have shown and described several embodiments in accordance with our invention, it should be understood that disclosed embodiments are susceptible to changes and modifications without departing from the scope of the invention. Therefore, we do not intend to be bound by the details shown and described herein but intend to cover all such changes and modifications as fall within the ambit of the appended claims.

What is claimed is:

1. An optical pickup for emitting light toward an optical disc having a plurality of layers and receiving light reflected from the optical disc, the optical pickup comprising:
a laser diode;
a diffraction device which receives an optical beam from the laser diode and separates the optical beam into a zero-order light beam, a plus first-order light beam, and a minus first-order light beam;
a polarization means which receives the zero-order light beam, the plus first-order light beam, and the minus first-order light beam from the diffraction device and polarizes the received light beams so that the zero-order light beam is polarized in a direction orthogonal to the direction in which the plus first-order light beam and the minus first-order light beam are polarized;
an objective lens which condenses the optical beams passing through the diffraction device on the optical disc; and
a detector which receives light reflected from the optical disc;
wherein the detector receives the zero-order light and the plus and minus first-order light that are rendered orthogonal to each other by the polarization means.

2. An optical pickup for emitting light toward an optical disc having a plurality of layers and receiving light reflected from the optical disc, the optical pickup comprising:
a laser diode;
a polarization diffraction device which receives an optical beam from the laser diode, separates the optical beam into a zero-order light beam, a plus first-order light beam, and a minus first-order light beam, and polarizes the received light beams so that the zero-order light beam is polarized in a direction orthogonal to the direction in which the plus first-order light beam and the minus first-order light beam are polarized;
an objective lens which condenses the optical beams passing through the polarization diffraction device on the optical disc; and
a detector which receives light reflected from the optical disc.

3. The optical pickup according to claim 1, wherein the light quantity ratio between the zero-order light and the plus and minus first-order light ranges from 10:1 to 20:1.

4. The optical pickup according to claim 2, wherein the light quantity ratio between the zero-order light and the plus and minus first-order light ranges from 10:1 to 20:1.

5. The optical pickup according to claim 1, wherein a half wavelength plate, which provides half the oscillation wavelength of the laser diode, is positioned between the laser diode and the diffraction device.

6. The optical pickup according to claim 2, wherein a half wavelength plate, which provides half the oscillation wavelength of the laser diode, is positioned between the laser diode and the polarization diffraction device.

7. The optical pickup according to claim 3, wherein a half wavelength plate, which provides half the oscillation wavelength of the laser diode, is positioned between the laser diode and the diffraction device.

8. The optical pickup according to claim 4, wherein a half wavelength plate, which provides half the oscillation wavelength of the laser diode, is positioned between the laser diode and the polarization diffraction device.

9. An optical drive comprising:
the optical pickup according to claim 1; and
a servo signal generation circuit which generates a focusing error signal and a tracking error signal by using a signal output from the optical pickup;
wherein the servo signal generation circuit is capable of generating a tracking signal according to a differential push-pull method.

10. An optical drive comprising:
the optical pickup according to claim 2; and
a servo signal generation circuit which generates a focusing error signal and a tracking error signal by using a signal output from the optical pickup;
wherein the servo signal generation circuit is capable of generating a tracking signal according to a differential push-pull method.

11. An optical drive comprising:
the optical pickup according to claim 3; and
a servo signal generation circuit which generates a focusing error signal and a tracking error signal by using a signal output from the optical pickup;
wherein the servo signal generation circuit is capable of generating a tracking signal according to a differential push-pull method.

12. An optical drive comprising:
the optical pickup according to claim 4; and
a servo signal generation circuit which generates a focusing error signal and a tracking error signal by using a signal output from the optical pickup;
wherein the servo signal generation circuit is capable of generating a tracking signal according to a differential push-pull method.

13. An optical drive comprising:
the optical pickup according to claim 5; and
a servo signal generation circuit which generates a focusing error signal and a tracking error signal by using a signal output from the optical pickup;
wherein the servo signal generation circuit is capable of generating a tracking signal according to a differential push-pull method.

14. An optical drive comprising:
the optical pickup according to claim 6; and
a servo signal generation circuit which generates a focusing error signal and a tracking error signal by using a signal output from the optical pickup;
wherein the servo signal generation circuit is capable of generating a tracking signal according to a differential push-pull method.

15. An optical drive comprising:
the optical pickup according to claim 7; and
a servo signal generation circuit which generates a focusing error signal and a tracking error signal by using a signal output from the optical pickup;
wherein the servo signal generation circuit is capable of generating a tracking signal according to a differential push-pull method.

16. An optical drive comprising:
the optical pickup according to claim 8; and
a servo signal generation circuit which generates a focusing error signal and a tracking error signal by using a signal output from the optical pickup;
wherein the servo signal generation circuit is capable of generating a tracking signal according to a differential push-pull method.
